(19) United States
(12) Patent Application Publication
(10) Pub. No.: US 2015/0015505 A1
(43) Pub. Date: Jan. 15, 2015

(54) MOBILE TERMINAL AND CONTROLLING METHOD THEREOF

(71) Applicant: LG Electronics Inc., Seoul (KR)

(72) Inventors: Sunhyuk LEE, Seoul (KR); Jimyong JUNG, Seoul (KR); Bumbae KIM, Seoul (KR)

(21) Appl. No.: 14/305,901

(22) Filed: Jun. 16, 2014

(30) Foreign Application Priority Data
Jul. 9, 2013 (KR) 10-2013-0080535

(51) Int. Cl. G06F 3/041; G06F 3/16

(52) U.S. Cl. CPC G06F 3/0416; G06F 3/0412; G06F 3/167
USPC 345/173

(57) ABSTRACT

A mobile terminal including a wireless communication unit configured to provide wireless communication; a touchscreen; a memory; and a controller configured to display an active screen of an executing application on the touchscreen, detect a plurality of touch gestures sequentially input to the active screen of the executing application, and create a guide content by saving touch event information in the memory corresponding to the plurality of the detected touch gestures in order of the sequential input.

Pursuant to 35 U.S.C. §119(a), this application claims the benefit of earlier filing date and right of priority to Korean Application No. 10-2013-0080535, filed on Jul. 9, 2013, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Discussion of the Related Art

A mobile terminal can perform various functions such as data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals. In addition, the mobile terminals can be further classified into handheld terminals and vehicle mounted terminals.

A terminal generally uses a touch screen as an input/output mechanism to secure its mobility or portability. Thus, an input mechanism and an output mechanism can be integrated into a single touchscreen.

However, when using a touchscreen as an input mechanism, a manipulation of the touchscreen is not intuitive. In addition, it is difficult to facilitate a description of a manipulating method of the touchscreen. Thus, the demands for a terminal for providing a guidance of a terminal manipulating method easily and intuitively and controlling method thereof are increasingly rising.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide a mobile terminal and controlling method thereof, by which a guide content indicating a terminal controlling method more easily and intuitively can be formed or played.

Additional advantages, objects, and features of the invention will be set forth in the invention herein as well as the accompanying drawings. Such aspects may also be appreciated by those skilled in the art based on the invention herein.

To achieve these objects and other advantages and in accordance with the purpose of the invention, as embodied and broadly described herein, a mobile terminal according to the present invention may include a touchscreen, a memory, and a controller outputting an active screen of a prescribed application to the touchscreen, the controller detecting a plurality of touch gestures sequentially input to the active screen of the prescribed application, the controller creating a guide content in which touch event information of each of a plurality of the detected touch gestures is saved in order of the sequential input.

In another aspect of the present invention, as embodied and broadly described herein, a method of controlling a mobile terminal according to the present invention may include the steps of outputting an active screen of a prescribed application to a touchscreen, detecting a plurality of touch gestures sequentially input to the active screen of the prescribed application, and creating a guide content in which touch event information of each of a plurality of the detected touch gestures is saved in order of the sequential input.

It is to be understood that both the foregoing general description and the following detailed description of the present invention are and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram of a mobile terminal according to one embodiment of the present invention;

FIG. 2 is a front perspective diagram illustrating one example of a mobile or portable terminal according to the present invention;

FIG. 3 is a rear perspective diagram of the mobile terminal shown in FIG. 2;

FIG. 4 is a rear perspective diagram of a surface of a rear case exposed by separating a rear cover of a mobile terminal according to one embodiment of the present invention;

FIG. 5 is a diagram illustrating one example of a method of entering a recording mode of a guide content according to one embodiment of the present invention;

FIG. 6 is a diagram of a state that an application recording mode is entered according to one embodiment of the present invention;

FIG. 7 is a state diagram of a recording mode to create a guide content according to one embodiment of the present invention;

FIG. 8 is a diagram illustrating one example of a play mode according to one embodiment of the present invention;

FIG. 9 is a diagram illustrating one example of an operation of selecting a ‘follow me’ play mode according to one embodiment of the present invention;

FIG. 10 is a diagram of a ‘follow me’ play mode of a guide content starting to be played before an entry into a target application;

FIG. 11 is a diagram of a ‘follow me’ play mode of a guide content starting to be played after an entry into a target application;

FIGS. 12 to 14 are diagrams of ‘follow me’ play modes in mobile terminals in different user environments according to one embodiment of the present invention, respectively;

FIG. 13 is a diagram to describe a ‘follow me’ play mode for a playback before a target application entry;

FIG. 14 is a diagram to describe a ‘follow me’ play mode for a playback after a target application entry;

FIG. 15 is a diagram illustrating one example of managing a guide content by a gallery application for managing photos or videos according to one embodiment of the present invention;

FIG. 16 is a diagram illustrating one example of skipping a touch guide in play mode according to one embodiment of the present invention;

FIG. 17 is a diagram illustrating one example of a method of merging a plurality of guide contents into one according to one embodiment of the present invention;

FIG. 18 is a diagram illustrating a method of playing an merged guide content according to one embodiment of the present invention; and

FIG. 19 is a flowchart of a recording operation according to one embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the invention only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

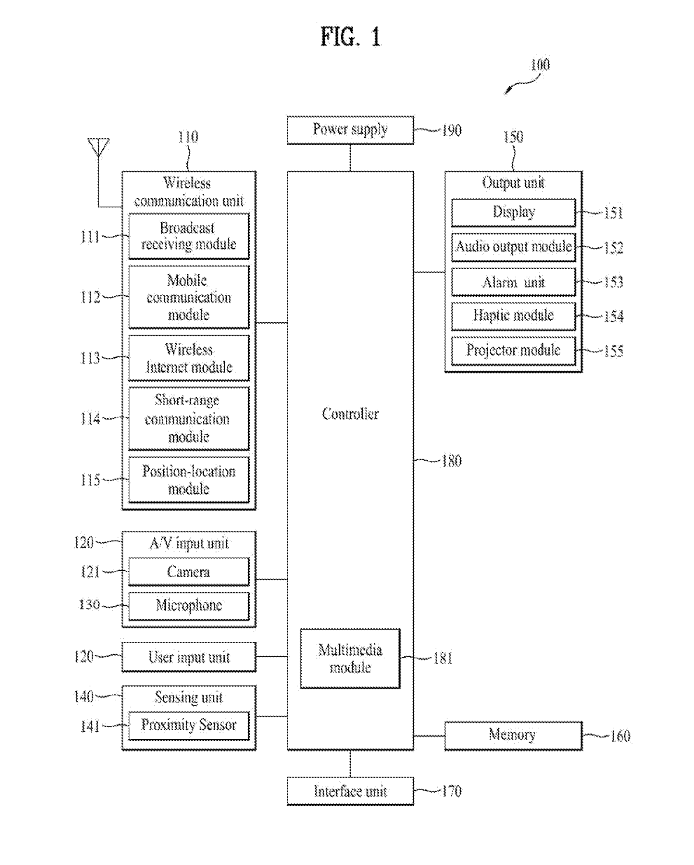

FIG. 1 is a block diagram of a mobile terminal 100 in accordance with an embodiment of the present invention. FIG. 1 shows the mobile terminal 100 including a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel. The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation. The broadcast associated information includes information associated with a broadcast channel, a broadcast program, a broadcast service provider, etc. In addition, the broadcast associated information can be provided via a mobile communication network. In this instance, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems. The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this instance, the wireless Internet technology can include WLAN(Wireless LAN) (Wi-Fi), Wibro (Wireless broadband), Wimax (World Interoperability for Microwave Access), HSDPA(High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 can precisely calculate current 3-dimensional position information based on at least one of longitude, latitude and altitude and direction (or orientation) by calculating distance information and precise time information from at least three satellites and then applying triangulation to the calculated information. Currently, location and time information are calculated using three satellites, and errors of the calculated location position and time information are then amended using another satellite. Besides, the GPS module 115 can calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. In addition, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 when a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100, and free-falling of the mobile terminal 100.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. In addition, the sensing unit 140 can include a proximity sensor 141.

The output unit 150 generates outputs relevant to the senses of sight, hearing, touch and the like. In addition, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user can see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

When the display 151 and a sensor for detecting a touch action (hereinafter called ‘touch sensor’) configures a mutual layer structure (hereinafter called ‘touchscreen’), it can use the display 151 as an input device as well as an output device. In this instance, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it can configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 can know whether a prescribed portion of the display 151 is touched.

The proximity sensor 141 can be provided to an internal area of the mobile terminal 100 enclosed by the touchscreen or around the touchscreen. The proximity sensor 141 is the sensor that detects a presence or non-presence of an object approaching a prescribed detecting surface or an object existing around the proximity sensor using an electromagnetic field strength or infrared ray without mechanical contact. Hence, the proximity sensor 141 has durability longer than that of a contact type sensor and also has utility wider than that of the contact type sensor.

The proximity sensor 141 can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this instance, the touchscreen (touch sensor) can be classified as the proximity sensor.

The proximity sensor 141 detects a proximity touch and a proximity touch pattern (e.g., a proximity touch distance, a proximity touch duration, a proximity touch position, a proximity touch shift state, etc.). In addition, information corresponding to the detected proximity touch action and the detected proximity touch pattern can be output to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 can output a signal for announcing the event occurrence by way of vibration as well as video or audio signal. The video or audio signal can be output via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be output in a manner of being synthesized together or can be output in sequence.

The haptic module 154 can generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. In addition, the projector module 155 can display an image, which is identical to or partially different at least from the image displayed on the display unit 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. In addition, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. In addition, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. In addition, a recent use history or a cumulative use frequency of each data (e.g., use frequency for each phonebook, each message or each multimedia) can be stored in the memory unit 160. Moreover, data for various patterns of vibration and/or sound output when a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. In addition, the mobile terminal 100 can operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals input from the cradle by a user to the mobile terminal 100. Each of the various command signals input from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 can perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

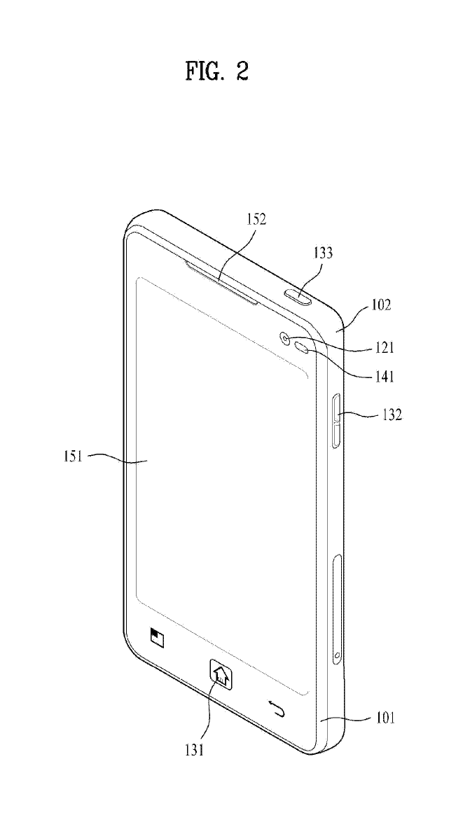

FIG. 2 is a front perspective diagram of a mobile terminal according to one embodiment of the present invention. The mobile terminal 100 shown in the drawing has a bar type terminal body. However, the mobile terminal 100 may be implemented in a variety of different configurations. Examples of such configurations include folder-type, slide-type, rotational-type, swing-type and combinations thereof. For clarity, further invention will primarily relate to a bar-type mobile terminal 100. However such teachings apply equally to other types of mobile terminals.

Referring to FIG. 2, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition. The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

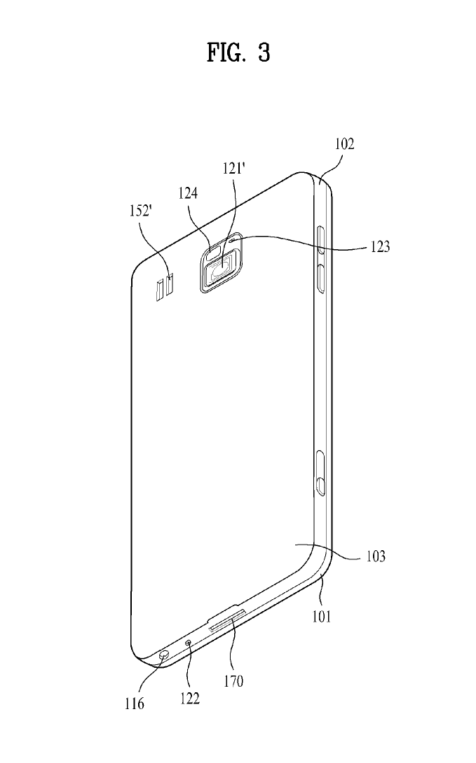

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 (see FIG. 3) can be provided to lateral sides of the front and rear cases 101 and 102.

The input unit 130 is manipulated to receive a command for controlling an operation of the terminal 100. In addition, the input unit 130 can include a plurality of manipulating units 131 and 132. The manipulating units 131 and 132 can be named a manipulating portion and may adopt any mechanism of a tactile manner that enables a user to perform a manipulation action by experiencing a tactile feeling.

Content input by the first or second manipulating unit 131 or 132 can be diversely set. For instance, such a command as start, end, scroll and the like is input to the first manipulating unit 131. In addition, a command for a volume adjustment of sound output from the audio output unit 152, a command for a switching to a touch recognizing mode of the display 151 or the like can be input to the second manipulating unit 132.

Next, FIG. 3 is a perspective diagram of a backside of the terminal shown in FIG. 2. Referring to FIG. 3, a camera 121′ can be additionally provided to a backside of the terminal body, and more particularly, to the rear case 102. The camera 121 has a photographing direction that is substantially opposite to that of the camera 121 and may have pixels differing from those of the camera 121.

Preferably, for instance, the camera 121 has low pixels enough to capture and transmit a picture of user's face for a video call, while the camera 121′ has high pixels for capturing a general subject for photography without transmitting the captured subject. In addition, each of the cameras 121 and 121′ can be installed at the terminal body to be rotated or popped up.

A flash 123 and a mirror 124 are additionally provided adjacent to the camera 121′. The flash 123 projects light toward a subject when photographing the subject using the camera 121′. When a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ can implement a stereo function together with the former audio output unit 152 shown in FIG. 2 and may be used for implementation of a speakerphone mode in talking over the terminal.

A broadcast signal receiving antenna 116 can be additionally provided to the lateral side of the terminal body as well as an antenna for communication or the like. The antenna 116 constructing a portion of the broadcast receiving module 111 shown in FIG. 1 can be retractably provided to the terminal body.

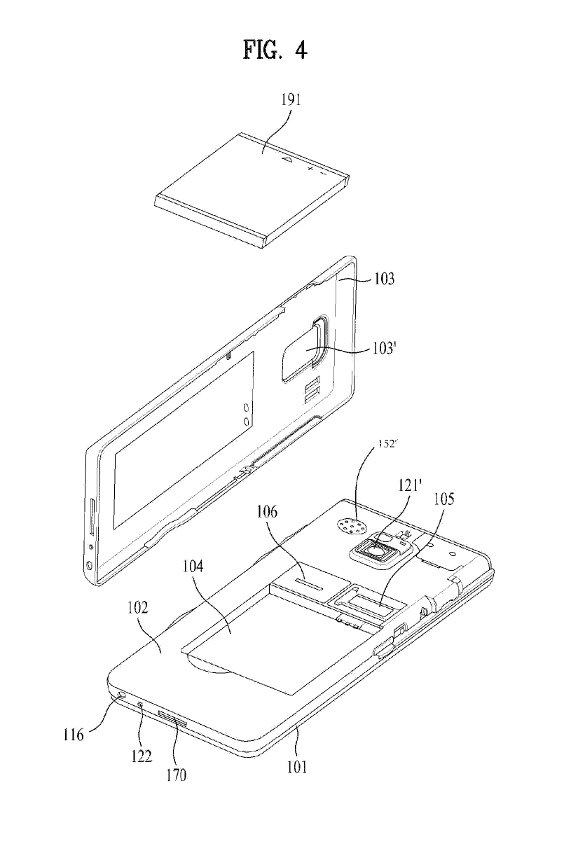

Next, FIG. 4 is a rear perspective diagram of a surface of a rear case exposed by separating a rear cover of a mobile terminal according to one embodiment of the present invention. Referring to FIG. 4, a front case 101, a rear case 102, a rear cover (or a battery cover) 103, a camera 121′, an interface unit 170, a microphone 122, a speaker module 154, an audio output unit 152′, a battery 191, a battery loading unit 104, a USIM card loading unit 105, and a memory card loading unit 106 are provided.

A space for mounting such an external part as the battery loading unit 104, the USIM card loading unit 105, the memory card loading unit 106 and the like can be provided to a surface of the rear case 102. Generally, the external part loaded on the surface of the rear case 102 is provided to extend functions of the mobile terminal 100 in order to meet the diversified functions of the mobile terminal and a variety of the consumer's needs.

As the performance of the mobile terminal gets diverse, the battery 191 can be configured as a replaceable type, as shown in FIG. 4, to complement a considerable amount of power consumption. When the replaceable type is adopted, the battery loading unit 104 is formed on the surface of the rear case 102 to enable a user to detach the corresponding battery. In this instance, a contact terminal is provided to the battery loading unit 104 to be electrically connected to a part installed within the case.

The USIM card loading unit 105 or the memory card loading unit 106 may be provided, as shown in FIG. 4, next to the battery loading unit 104. Alternatively, the USIM card loading unit 105 or the memory card loading unit 106 may be provided to a bottom surface of the battery loading unit 104. Hence, the battery 191 can be externally exposed if the battery 191 is unloaded from the battery loading unit 104. In this instance, since a size of the battery loading unit 104 is extensible, the battery 191 can be oversized.

Although FIG. 4 shows the configuration that the USIM card loading unit 105 or the memory card loading unit 106 is mounted on a backside of the rear case 102, it can be inserted in or separated from the mobile terminal 100 by being inserted in a lateral side of the rear case 102.

The rear cover 103 covers the surface of the rear case 102. Hence, the rear cover 103 can fix the battery, 191, the USIM card, the memory card, etc. not to be separated from the rear case 102 and also protects the external parts from external shocks or particles. Recently, a waterproof function is added to the mobile terminal 100. In order to prevent the external parts from contacting with water, the mobile terminal 100 can further include a waterproof structure. Hence, when the rear case 102 and the rear cover 103 are connected to each other, the waterproof structure can seal the gap between the rear case 102 and the rear cover 103.

As mentioned in the foregoing description, various types of touch gestures can exist. In addition, a type of an input through a touchscreen varies depending on a screen currently output to the touchscreen. For instance, touch inputs to the same location on a touchscreen are detected as different types of inputs for applying a touch input when outputting an ‘end’ button and for applying a touch input when outputting a ‘start’ button, respectively. Hence, in order to inform a third party of a terminal controlling method through a touchscreen, it is preferable to inform the third party of both a screen currently output through the touchscreen and a touch gesture input.

Therefore, according to one embodiment of the present invention, proposed are a terminal and controlling method thereof, by which an active screen of an application and a touch gesture input can be saved and played together. Thus, data, which is saved and played to inform a user of a terminal controlling method, is called a guide content in the following description. In particular, the guide content may indicate data saved in order of a sequential input of a touch event information of each of a plurality of detected touch gestures.

Meanwhile, in recording a guide content, when an output screen of the mobile terminal 100 in itself is recorded, a size of a created guide content may increase considerably. Therefore, according to one embodiment of the present invention, in recording a guide content, an output screen of the mobile terminal 100 in itself is not recorded. Instead, a basic data such as a touch gesture input through the touchscreen of the mobile terminal 100, an information of an application, a user's voice memo in recording, a user's handwriting memo and the like is only saved.

According to one embodiment of the present invention, when playing a guide content, the mobile terminal 100 activates the same application as used in the recording, outputs the same active screen as output in the recording, and delivers a controlling method using a touch gesture indicated by the guide content.

Thus, when the guide content is recorded or played, an active screen (i.e., an output screen) of the application should have the same output screen. Meanwhile, in the present specification, an application activated for a recording/playback of a guide content may be named a target application.

Method of Recording Guide Content (Guide Data)

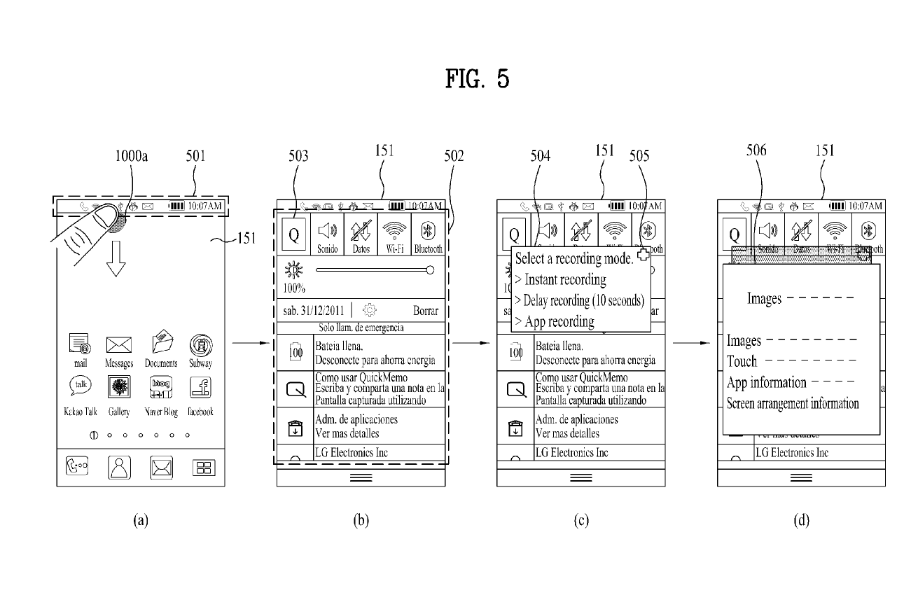

FIG. 5 is a diagram illustrating one example of a method of entering a recording mode of a guide content according to one embodiment of the present invention. A case configured to form an exterior shape of the mobile terminal 100 may not be illustrated in the following description.

Referring to FIG. 5, a recording icon 503 for entering a recording mode can be output to a screen of a control center 502 shown in FIG. 5 (b). In this instance, the control center 502 is a setting screen for manipulating various settings without activating a setting application. The control center 502 can be paged through a touch drag input 1000a (e.g., a touch drag input in a bottom direction from the indicator region. etc.) to an indicator region 501. In this instance, the various settings may include on/off of a Bluetooth function, on/off of a Wi-Fi function, a sound volume adjustment, a screen brightness adjustment and the like.

The indicator region 501, as shown in FIG. 5 (a), corresponds to a region for performing a function of representing various types of operating statuses (e.g., a current hour, a battery level, a radio signal reception strength, etc.) of the mobile terminal by being always displayed on a prescribed region of the display unit 151 except when displaying a prescribed application that uses a full screen.

If the controller 180 receives an input of selecting the recording icon 503, the controller 180 can directly enter a recording mode. Meanwhile, according to one embodiment of the present invention, the recording mode can be divided into a plurality of modes. In this instance, a plurality of the modes may include ‘instant recording mode’, ‘delay recording mode’ and ‘application recoding mode’.

The instant recording mode corresponds to a mode for recording a guide content according to one embodiment of the present invention by starting from a timing point ahead of a timing point (e.g., a timing point of touching the recording icon 503, etc.) of entering the recording mode by a prescribed time.

The application recording mode corresponds to a mode for recording a guide content according to one embodiment of the present invention by starting from (or right before) a timing point of entering a target application after entering the recording mode. In addition, when a plurality of recording modes exist, if the recording icon 503 is touched, the controller 180 can output a mode selection popup window 504 for selecting one of a plurality of the recording modes. If a prescribed recording mode is selected through the mode selection popup window 504, the controller 180 can start a recording of a guide content through the selected recording mode.

Meanwhile, one embodiment of the present invention provides an interface configured to control settings for a recording of a guide content. If the controller 180 receives a setting button 505 in the mode selection popup window 504, referring to FIG. 5 (d), the controller 180 can output a setting control window 506 allowing the user to select recording items (or elements to be saved) for the guide content.

In addition, the recording items can include at least one of an output image of a target application, a touch event information of a touch gesture, information on a target application (including a setting information of a target application, a version information of a target application) and a screen arrangement information. For instance, according to one embodiment of the present invention, if the guide content includes a recording of ‘images’, when the controller 180 records the guide content, the controller 180 can save an output screen of a target application together with the guide content.

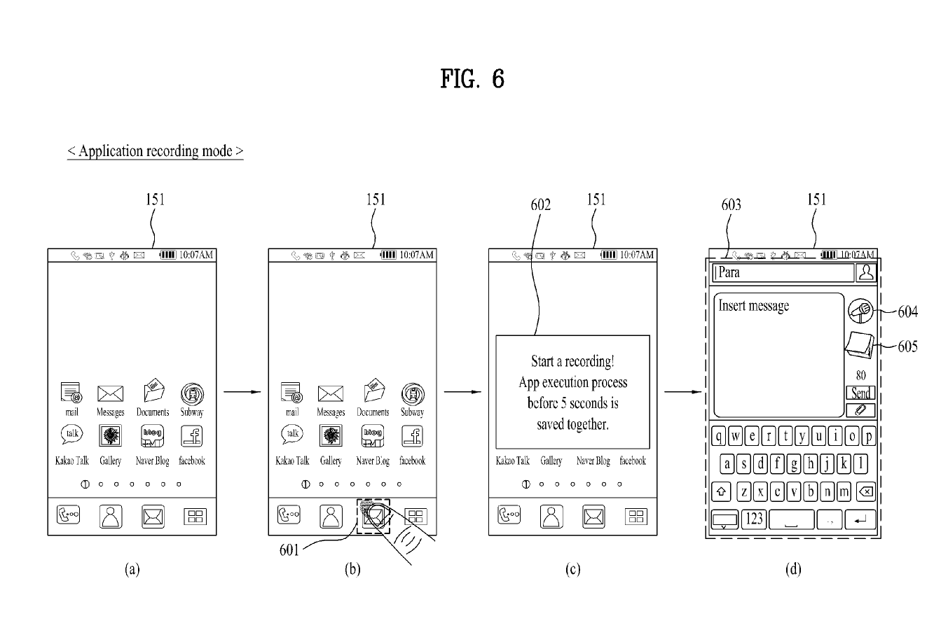

In the following description, the application recording mode shall be explained in detail with reference to FIG. 6. In particular, FIG. 6 is a diagram illustrating an application recording mode being entered according to one embodiment of the present invention. In the example described with reference to FIG. 6, a recording mode creates a guide content for a message application (i.e., a target application in FIG. 6 is a message application).

Referring to FIG. 6, in an application recording mode according to one embodiment of the present invention, even if a recording mode is entered, a recording of a guide content is not started instantly. Instead, a recording of a guide content is not started until a target application is activated (or until expiration of a prescribed time before a timing point of activating a target application). Hence, since a target application has not been activated in FIG. 6 (a), the controller 180 does not start a recording of a guide content.

Referring to FIG. 6 (b), if a target application 601 is started (e.g., a message application in the example shown in FIG. 6), the controller 180 can start a recording of a guide content. Alternatively, as mentioned in the above description, the controller 180 can start a recording of a guide content by starting from a prescribed time ahead of a timing point of activating a target application (e.g., a message application in the example). In this instance, ‘recording past data’ can be interpreted as follows. First of all, the controller 180 keeps performing a recording operation. Thus, a timing point of starting to save the recorded data is a past timing point.

In particular, according to one embodiment of the present invention, if the application recording mode is entered, the controller 180 keeps performing the recording operation. However, the controller 180 can control the recorded data to be saved by staring from a prescribed time ahead of a timing point of activating a target application. Thus, the recorded data starts to be saved before the timing point of activating the target application. The reason for this is to guide a controlling method before entering an active screen of the target application.

Referring to FIG. 6 (c), the controller 180 can output an announcement popup window 602 indicating a start timing point of a recording. Referring to FIG. 6 (d), the controller 180 can output an active screen 603 of the activated target application 601.

Meanwhile, according to one embodiment of the present invention, in a recoding mode, identification information (e.g., at least one of a title and a version information included) of an activated target application can be saved together. The reason for this is described as follows. First of all, when a guide content is played, an output screen of a target application can be played together.

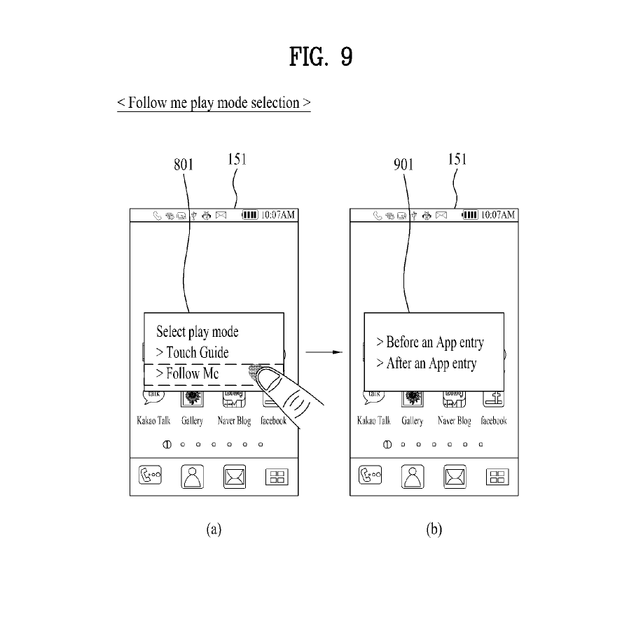

Thus, the output screen may vary depending on a type and version of the target application. Therefore, a guide content saved in a recording mode according to one embodiment of the present invention can include identification information of a target application together in order to be played when a type and version of the target information are identical. Details for playing the guide content are described with reference to FIGS. 9 to 13 later.

Moreover, according to one embodiment of the present invention, in a recording mode, a user's voice memo, a user's handwriting memo and a specific sound data can be saved together. In particular, when a recording mode is entered, the controller 180 automatically activates the microphone. Hence, the controller 180 receives an input of a voice memo from a user as soon as entering the recording mode.

In addition, the controller 180 can save the received voice memo together with a guide content. Meanwhile, the controller 180 can output a recording indicator 604 indicating that the voice memo is being recorded together. In addition, the controller 180 can switch a status of the recording to a pause/resume in response to an input of touching the recording indicator 604.

When the controller 180 enters the recording mode, the controller 180 displays a separate handwriting memo input window on a prescribed region of the touchscreen 151 and can then save a user's handwriting memo, which is input to the handwriting memo input window, together with the guide content. Alternatively, the controller 180 outputs a memo icon 605 for activating a memo function and can then output a handwriting memo input window in response to an input of touching the memo icon 605.

Moreover, the controller 180 can save audio data of an application output in the recording mode together with the guide content. When the guide content is played in a play mode, the saved data can be output as well. In addition, whether to save the corresponding data can be set by a user's setting.

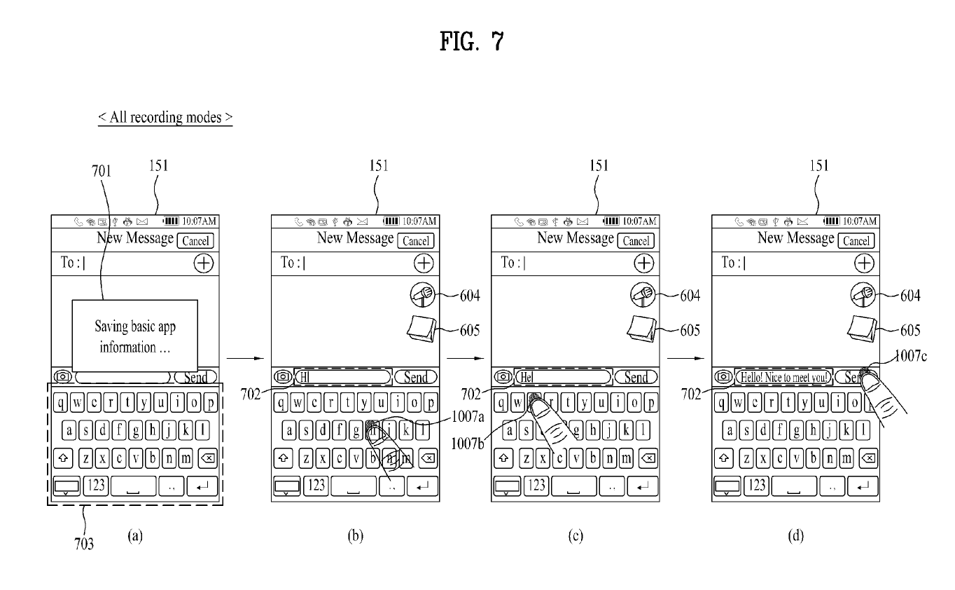

FIG. 7 is a state diagram of a recording mode to create a guide content according to one embodiment of the present invention. In particular, FIG. 7 shows one example of a recording mode for recording a guide content for a message transceiving application.

Referring to FIG. 7, an active screen of a message transceiving application can include a keypad region 703 for outputting a virtual keypad to receive an input of a typing information from a user and an input region 702 for outputting the typing information input from the keypad region 503.

Meanwhile, according to one embodiment of the present invention, if a recording mode is entered, the controller 180 records a guide content and can further save additional information on a target application status. In this instance, the additional information on the target application status corresponds to setting information for varying an output screen of the target application.

For instance, in an output screen of the message transceiving application shown in FIG. 7 (a), the virtual keypad output to the keypad region 703 can be changed in response to a keyboard setting. If the keyboard setting is set to ‘Korean’, a virtual keypad for inputting Korean is output. If the keyboard setting is set to ‘English’, a virtual keypad for inputting English is output.

Therefore, according to one embodiment of the present invention, setting information for varying an output screen of a target application is saved together with a guide content so that an output screen of the target application output in recording the guide content and an output screen of the target application output in playing the guide content can match each other. The reason for this is that an accurate control method can be delivered using the guide content only if the two output screens match each other. If an output screen of the target application output in recording the guide content is different from an output screen of the target application output in playing the guide content, a user may not be able to obtain the accurate control method using the guide content.

The controller 180, as shown in FIG. 7 (a), can output a popup window 701 announcing that the additional information on the application status has been saved. In the examples shown in FIGS. 7 (b) to 7 (d), a user is applying inputs 1007a to 1007c of a sentence ‘Hello! Nice to meet you!’ through the keypad region 703. Each time each text is typed, the corresponding typed text may be output through the input region 702.

According to one embodiment of the present invention, the controller 180 can detect a plurality of touch gestures sequentially input to an active screen of a target application in a recording mode. Subsequently, the controller 180 can create a guide content in which touch event information of a plurality of the detected touch gestures are saved in order of the sequential input.

Referring to FIG. 7 (b), if the controller 180 receives the touch input 1007a for an H-key, the controller 180 can save a touch event information on the touch input 1007a. In this instance, the touch event information corresponds to a property information of an input touch gesture.

In particular, the touch event information can include at least one of coordinates information of the input touch gesture and gesture type information of the input touch gesture. That is, the coordinate information of the touch gesture corresponds to a location information of a location on the touch gesture input touchscreen. In addition, the gesture type information corresponds to a type of the touch gesture. The touch gesture information can include at least one of a normal touch type, a long touch type, a touch & drag type, a press type, a multi-touch type, a flicking type, a pinch-in type and a pinch-out type.

Moreover, in FIG. 7 (b), the controller 180 can further save identification information of a key selected by the touch gesture as well as the coordinate information of the touch gesture. For instance, in FIG. 7 (b), if the touch input 1007a to the H-key is received, identification information of the H-key can be further saved as well as the coordinate information on the touch input 1007a.

As mentioned in the above description, the reason for further saving an identification of a selected key is that a location of a touch input may vary slightly on each active screen of a target application. For instance, when a resolution of a screen corresponds to a first resolution, after a guide content has been recorded, it may be able to consider a case that the guide content is played in another mobile terminal 100 having a screen resolution set to a second resolution.

Because there are different resolutions, if a coordinate information of a touch gesture exists only, a location for applying a touch thereto may vary. Therefore, according to one embodiment of the present invention, the controller 180 further saves identification information of a selected touch item (e.g., a key selected from a virtual keypad shown in FIG. 7). The controller 180 can record the guide content by sequentially saving the touch event information on the touch gestures 1007a and 1007b received in the course of inputting a whole sentence.

If the controller 180 receives an input for terminating the target application (e.g., an input of selecting a home key), the controller 180 can end the recording mode. So far, a recording mode for recording a guide content has been described. In the following description, a play mode for playing the recorded guide content shall be explained in detail with reference to the accompanying drawings.

Method of Playing Guide Data

According to one embodiment of the present invention, guide contents may be managed and played through separate applications or can be managed and/or played in a gallery application together with other photos and videos.

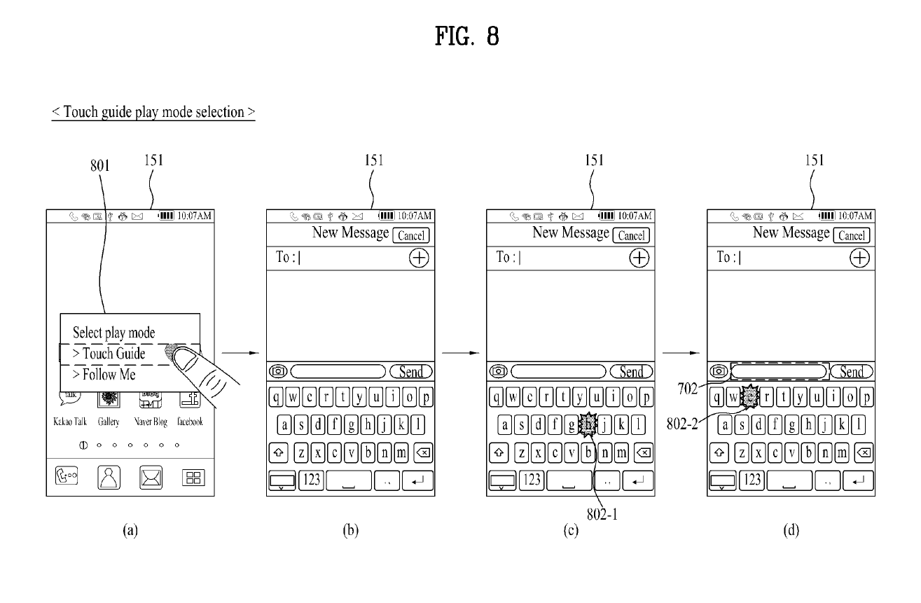

FIG. 8 is a diagram illustrating one example of a play mode according to one embodiment of the present invention. Referring to FIG. 8, a method of playing a guide content according to one embodiment of the present invention may include a plurality of play modes. In this instance, a plurality of the play modes may include at least one of a play mode ‘touch guide’ and a play mode ‘follow me’.

Hence, referring to FIG. 8 (a), if the controller 180 receives a play command for a specific guide content, the controller 180 can output a popup window 801 for receiving a selection of a play mode.

The play mode ‘touch guide’ corresponds to a mode for displaying a series of touch gestures, which were sequentially input in a recording mode, in order of input. In this instance, in displaying the touch gestures, the controller 180 can output an indicator 802-1/802-2 to a touch gesture input location (FIG. 8 (c), FIG. 8 (d)). In particular, the play mode ‘touch guide’ corresponds to a play mode for sequentially displaying regions touched during a recording in order of a time flow.

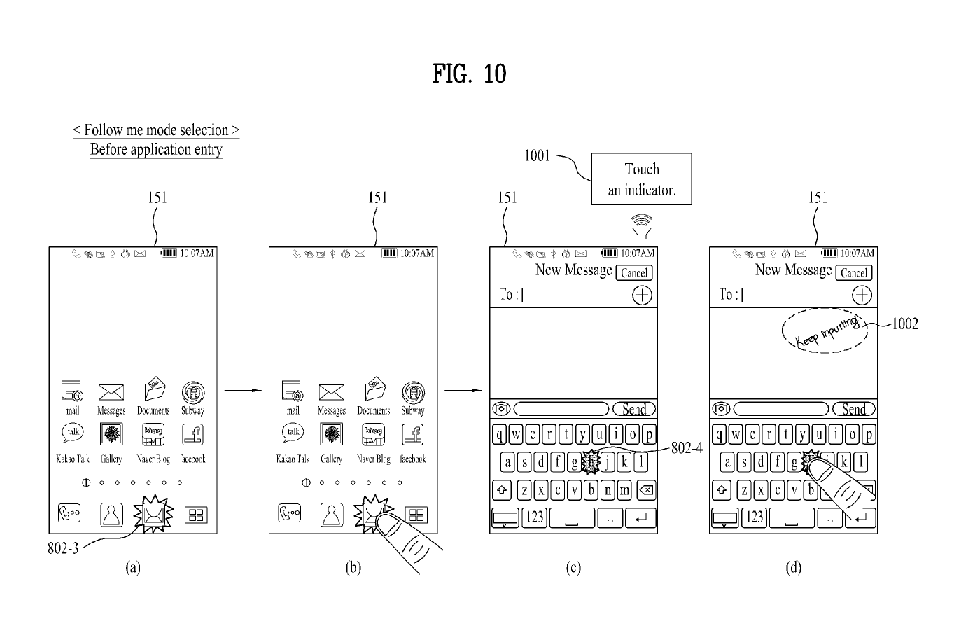

The touch guide play mode may need a recording of images. Hence, if the recording item is not set to ‘images’ in FIG. 5 (d), the play mode ‘touch guide’ may not be available. In this instance, the selection item ‘touch guide’ in the popup window 801 is disabled to indicate that it is not selectable by a user. In addition, the guide content having the recording item not set to ‘images’ may operate in the play mode ‘follow me’ only. The play mode ‘follow me’ is described in detail with reference to FIG. 10 later.

FIGS. 8 (b) to 8 (d) shows state diagrams for entering the play mode ‘touch guide’. The controller 180 outputs a play screen of a guide content. In this instance, the play screen can include an active screen of a target application and a plurality of touch guide indicators for displaying the input touch gestures on the active screen sequentially.

Referring to FIG. 8 (b), the controller 180 currently outputs an active screen of a message transceiving application. Referring to FIG. 8 (c) and FIG. 8 (d), the controller 180 sequentially displays touch guide indicators 802-1 and 802-1 sequentially.

Meanwhile, the touch guide indicators 802-1 and 802-1 can be displayed by the controller 180 by being emphasized. As an example of the emphasized display, regions except the touch guide indicators 802-1 and 802-1 can be displayed by being shaded or dimmed (or deactivated).

In the following description, the play mode ‘follow me’ is explained in detail with reference to FIGS. 9 to 11. In particular, FIG. 9 is a diagram illustrating one example of an operation of selecting a play mode ‘follow me’ according to one embodiment of the present invention.

According to one embodiment of the present invention, a play mode ‘follow me’ can be sorted into two types including a first type and a second type. In particular, the play mode play mode ‘follow me’ can be sorted into the first type mode for starting to play a guide content before an entry into an active screen of a target application and the second type mode for playing a guide content after an entry into an active screen of a target application. Therefore, if the play mode ‘follow me’ is selected, the controller 180 can output a selection popup window 901 for selecting one of the two types of the play modes.

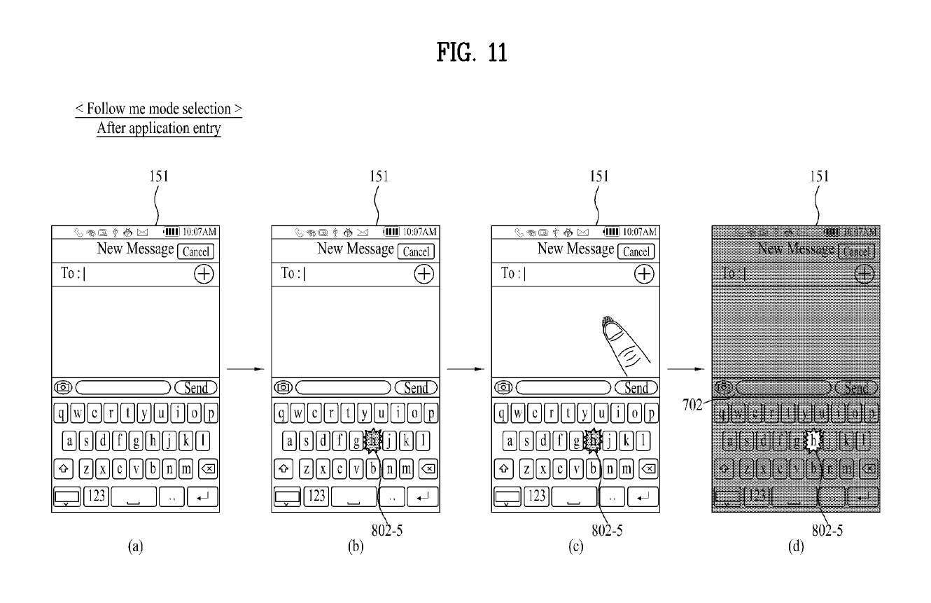

FIG. 10 is a diagram of a play mode ‘follow me’ of a guide content starting to be played before an entry into a target application. In addition, FIG. 11 is a diagram of a play mode ‘follow me’ of a guide content starting to be played after an entry into a target application.

Meanwhile, in recording a guide content, when a recording operation has already started after an entry into a target application, the controller 180 can operate to automatically play the guide content after the entry into the target application without a selection of the play mode.

The play mode ‘follow me’ corresponds to a play mode for guiding a user's touch participation in playing a guide content. The play mode ‘touch guide’ is the play mode for displaying an input touch gesture along a flow of time without guiding a user's touch participation. Compared to the play mode, the play mode ‘follow me’ corresponds to the play mode for displaying a next touch gesture sequentially if there is a user's touch participation irrespective of a flow of time.

Referring to FIG. 10 (a), in play mode ‘follow me’, the controller 180 currently displays an output screen of an application and a third touch guide indicator 802-3. While the controller 180 displays the third touch guide indicator 802-3, the controller 180 stands by for an input from a user.

Thus, the controller 180 can perform a display/audio output to guide a touch to the third touch guide indicator 802-3. In this instance, the audio output may include a specific sound, and more particularly, a guidance mention 1001 for guiding a touch to a touch guide indicator.

Meanwhile, the output screen of the application may not be saved in the aforementioned guide content. Hence, in providing the output screen of the application, the controller 180 can provide the output screen by activating the same target application using a touch event information saved in the guide content. Hence, according to one embodiment of the present invention, a size of a guide content is prevented from increasing due to saving an output screen, thereby being reduced.

For instance, a touch input corresponding to a touch guide indicator is the touch input 1007a in the recording mode shown in FIG. 7. In addition, a touch event information on this touch input includes an identification information on the H-key. Hence, if the touch guide indicator 802-4 is touched, the controller 180 can provide an output screen in a state that the H-key is input to an application.

In particular, when a guide content according to one embodiment of the present invention is played or recorded, the guide content can provide the same output screen without saving an output screen of a target application. Hence, referring to FIG. 10 (c) and FIG. 10 (d), while the touch guide indicator 802-4 is displayed, if the touch guide indicator 802-14 is touched, the controller 180 inputs the H-key to the application, thereby providing an output screen of the application in the H-key input state.

When an input from a user is an input of touching a location of the third touch guide indicator 802-3, the controller 180 can display the application output screen in the H-key input state and the fourth touch guide indicator 802-4 (FIG. 10 (b), FIG. 10 (c)). In addition, the controller 180 can perform an operation or function corresponding to this touch input. Since an activation icon of a message transceiving application is touched in the examples shown in FIG. 10 (b), the controller 180 displays the fourth touch guide indicator 802-4 and also activates the message transceiving application.

On the other hand, if an input from a user is an input of touching a region except the location of the third touch guide indicator 802-3, the controller 180 can output an expression (e.g., dimming other regions except the region of the third touch guide indicator 802-3, FIG. 11 (c)) for emphasizing the third touch guide indicator 802-3. Hence, one embodiment of the present invention can guide a user to participate in an accurate touch.

Likewise, in the state diagram shown in FIG. 10 in which the fourth touch guide indicator 802-4 is displayed, if the controller 180 receives an input of a touch to the fourth touch guide indicator 802-4, the controller 180 can output a touch guide indicator in the next order. In response to the input of the touch to the fourth touch guide indicator 802-4, the controller 180 can output a state diagram of the H-key input state on the message transceiving application.

Moreover, according to one embodiment of the present invention, if the controller 180 receives an input of the touch to the fourth touch guide indicator 802-4, the controller 180 can output a saved handwriting memo 1002 (or a voice memo through a speaker) while outputting an indicator in the next order. Thus, the play mode ‘follow me’, as shown in FIG. 10, can deliver a controlling method more effectively than the play mode ‘touch guide’ by guiding a user's touch participation. The play mode ‘follow me’ continues to be described with reference to FIG. 11 as follows.

FIG. 11 shows a play mode ‘follow me’ of a guide content starting to be played after an entry into a target application. Referring to FIG. 11, assume that a guide content has been recorded after an entry into a target application. Thus, if the guide content is played, the controller 180 automatically activates the target application and can output an active screen of the activated target application. The state diagram shown in FIG. 11 (a) illustrates the active screen of the target application automatically activated by the play of the guide content.

Once the guide content is played, referring to FIG. 11 (b), the controller 180 automatically activates the target application and can output a fifth touch guide indicator 802-5. The controller 180 can then stand by for a reception of a user's touch input.

If the user's touch input is applied to a location of the fifth touch guide indicator 802-5, the controller 180 can output a touch guide indicator in next order. If the user's touch input is applied to a region other than the location of the fifth touch guide indicator 802-5, referring to FIG. 11 (d), the controller 180 can control the fifth touch guide indicator 802-5 to be displayed by being emphasized. As one example of the emphasized display, referring to FIG. 11 (d), the controller 18 can dim other regions except a region of the fifth touch guide indicator 802-5.

Meanwhile, the play mode examples described with reference to FIGS. 8 to 11 relate to a guide content recording mobile terminal being identical to a guide content playing mobile terminal. Hence, regarding the former examples, a location of an icon for activating a target application in recording a guide content is identical to that in playing the guide content.

However, according to one embodiment of the present invention, it is preferable for the target application to be activated if a location of an icon for activating a target application in recording a guide content is different from that in playing the guide content as well as if a location of an icon for activating a target application in recording a guide content is identical to that in playing the guide content.

The reason for this is explained as follows. First of all, a guide content created according to one embodiment of the present invention will be provided to other users. Secondly, even if a guide content is played in the same mobile terminal, a location of the icon can be changed by a user's input. Moreover, because an output screen is changeable depending on an installation version of a target application, the installation version of the target application needs to be identically matched to each of a recording timing point and a playing timing point.

Hence, the following description explains a play mode when a mobile terminal user environment is different (e.g., a location of an icon of a target application is different, a target application is not installed at all, a version information of a prescribed application is different, etc.).

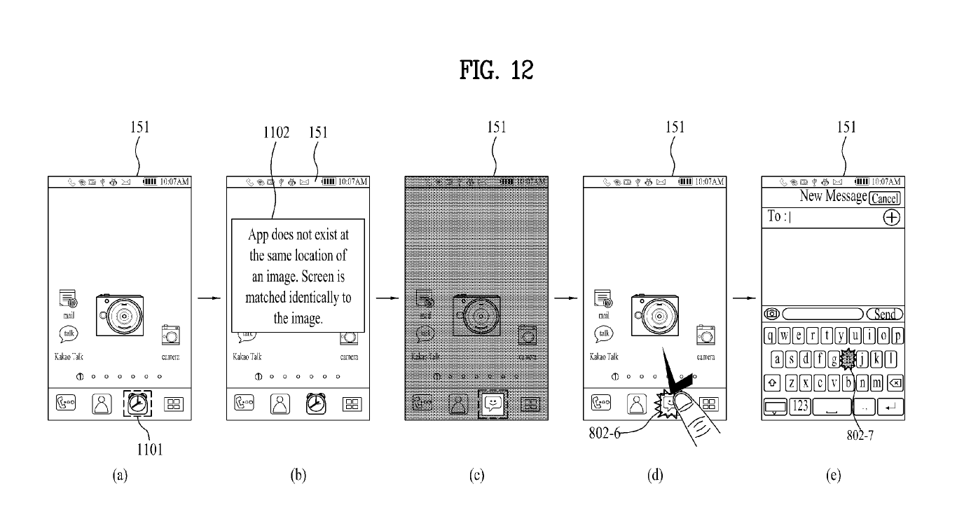

FIGS. 12 to 14 are diagrams of ‘follow me’ play modes in mobile terminals in different user environments according to one embodiment of the present invention, respectively. Referring to 12 (a), an activation icon 1101 of a different application (e.g., an alarm application) is situated at a location of a recording timing point of an activation icon of a target application of a guide content. When the guide content is played, it is necessary for a location of the activation icon of the target application to be shifted to the same location of the recording timing point. Hence, referring to FIG. 12 (c), the controller 180 can shift a location of an activation icon of a message application to the same location of the recording timing point. Thus, the controller 180 can output an announcement text 1102 indicating that a location of an icon can be shifted as shown in FIG. 12(b).

In the above-described embodiment, FIG. 12 (c) shows one example that an icon of a target application is shifted to a location at a timing point of performing a recording operation. However, according to another embodiment of the present invention, an icon of a target application is not shifted. However, a location of an icon of a currently present target application is displayed by being emphasized. In particular, by the installation of the target application, assume that the icon of the target application is situated at a location different from that in performing a recording. If so, the controller 180 detects the location of the icon of the target application and then emphasizes the detected location of the icon of the target application, thereby guiding a user's touch to the corresponding icon.

When a plurality of home screens exist in the mobile terminal 100, assume that an icon of a target application is located on a home screen different that for a recording. In this instance, the controller 180 switches a location of a home screen to another home screen having the icon of the target application exist therein, thereby controlling the icon of the target application to be displayed by being emphasized.

Moreover, when an icon of a target application does not exist in a home screen, assuming that the corresponding icon of the target application exists in a list of applications (or a menu screen), the controller 180 outputs the list of applications and then controls the icon of the target application to be displayed by being emphasized.

According to the play mode ‘follow me’, the operations of outputting a sixth touch guide indicator 802-6 and a seventh touch guide indicator 802-7 are equivalent to those described with reference to FIG. 10 and FIG. 11 (FIG. 12 (d), FIG. 12 (e)).

Meanwhile, depending on a setting status of a target application, it may happen that an output screen of the target application varies. This is mentioned in the former description of the recording mode. In the former example, the keypad region 703 varies depending on whether the language setting of the keyboard is set to ‘Korean’ or ‘English’. Therefore, based on the additional information on the target application status saved in the guide content, the controller 180 can change the settings of the target application operating in the play mode. Since the guide content shown in FIG. 7 is recorded by setting the keyboard language setting to English, the controller 180 can change the language setting to the same keyboard language ‘English’ in the play mode for the guide content.

On the other hand, if a guide content is played by starting after an activation of an application, it does not matter whether a recording timing point and a play timing point differ from each other in a location of an activation icon of a target application. This is because, if the guide content is played, as mentioned in the foregoing description with reference to FIG. 11, the controller 180 automatically activates the target application and then displays an output screen of the activated application. Hence, although the recording timing point and the play timing point differ from each other in the location of the activation icon of the target application, if the guide content is played after the activation of the target application, the controller 180 can perform the same operation as shown in FIG. 11.

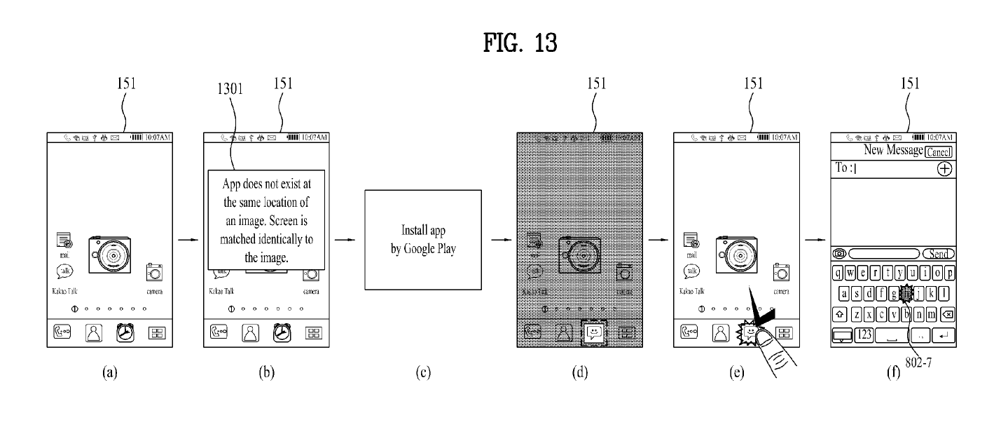

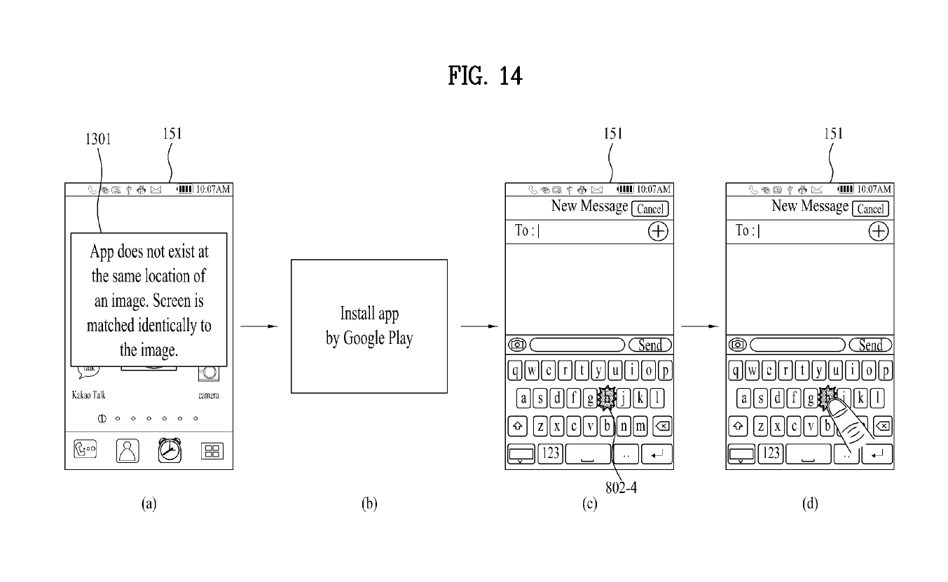

The following description explains, with reference to FIG. 13 and FIG. 14, a target application not being installed at all, and a version information of a prescribed application being different. In particular, FIG. 13 is a diagram illustrating a ‘follow me’ play mode for a playback before a target application entry. In addition, FIG. 14 is a diagram illustrating a ‘follow me’ play mode for a playback after a target application entry. The selection of ‘before play’ or ‘after play’ can be made by a user through the selection popup window 901 shown in FIG. 9.

FIG. 13 (a) is a state diagram before an entry into a target application. If a guide content is played in this state, the controller 180 checks whether a target application (e.g., an application activated in recording the guide content) is installed already. If the target application is installed already, the controller 180 can perform a play operation on the guide content by the process mentioned in the foregoing description. If the target application is not installed yet, according to one embodiment of the present invention, after the target application has been installed automatically, the guide content is played.

If the controller 180 determines that the target application is not installed yet, the controller 180 can output an announcement text 1301 indicating a process of installation. Subsequently, referring to FIG. 13 (c), it can install the target application by accessing a store application of the installation of the target application. In FIG. 13, as an example of the store application, there is a store ‘Google Play’. After the installation has been complete, the controller 180 shifts an activation icon of the installed target application to the same location of an icon at a recording timing point and can then display the corresponding location by emphasizing the corresponding location. As one example of the emphasized display, referring to FIG. 13 (d), the rest of regions except the location of the icon can be dimmed.

Meanwhile, for example, according to the embodiment described with reference to FIG. 13 (d), the icon of the installed target application is shifted to a location at a timing point for performing a recording operation. However, according to another embodiment of the present invention, a location of an icon of a currently existing target application is displayed by being emphasized without shifting the icon of the target application.

In particular, assume that the icon of the target application is situated at a location different from that of the recording due to the installation of the target application. If so, the controller 180 detects a location of the icon of the corresponding target application and then displays the detected location of the icon of the target application with an emphasis, thereby guiding a user's touch to the corresponding icon. Since a play mode shown in FIG. 13 (e) and FIG. 13 (f) is equal to that described with reference to FIG. 10, its details are omitted from the following description.

After completion of the play of the guide content, a user's selection can determine whether the location of the activation icon of the installed target application will be maintained intact or relocated at a new location (e.g., an empty space in a home screen, etc.). Meanwhile, according to one embodiment of the present invention, a target application is installed automatically like the case of performing a playback after a target application entry.

As a guide is played, if a target application is not installed yet, the controller 180 can output such an announcement text 1301 as shown in FIG. 14 (a). In this instance, the announcement text 1301 may include a text that guides an installation of the target application in a store application because of the absence of the target application. Subsequently, the controller 180 performs the installation of the target application (FIG. 14 (b)) and can then directly perform a guide content playing operation with an active screen of the target application (FIG. 14 (c), FIG. 14 (d)).

Meanwhile, according to the embodiments described with reference to FIG. 13 and FIG. 14, the absence of the installation of the target application is taken as an example. However, according to another embodiment of the present invention, the same principle of the descriptions with reference to FIG. 13 and FIG. 14 can be applied to different versions of target applications. In particular, the controller 180 further saves version information of target applications in a recording mode and can then check the version information of the corresponding target application in a play mode. If the version information in the recording mode is different from the version information in the play mode, it can install the same version by automatically accessing the aforementioned store application and then performing an update.

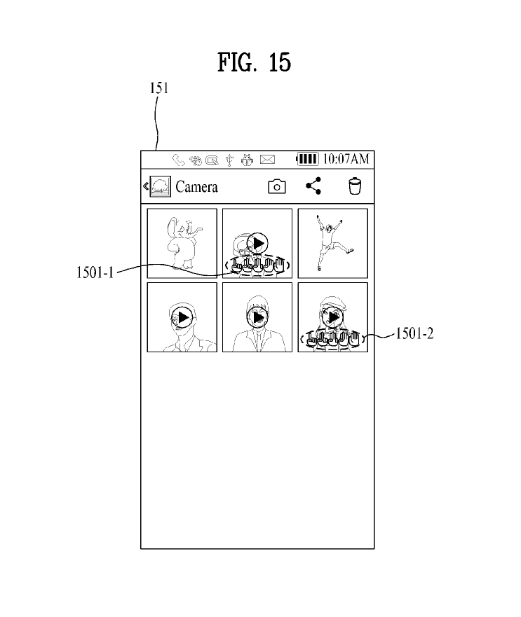

FIG. 15 is a diagram illustrating one example of managing a guide content by a gallery application for managing photos or videos according to one embodiment of the present invention. Referring to FIG. 15, a gallery application currently outputs a list of photos or videos. In addition, contents can be displayed by being included in the list.

To discriminate a guide content for photos from a guide content for videos, the controller 180 can output an indicator 1501-1/1501-2 indicating that it is the guide content. Alternatively, the controller 180 can save the guide content in a separate folder. In addition, an extension of the guide content can be used only instead of the same extension. If the guide content is selected from the list, the controller 180 can enter the guide content play mode mentioned in the foregoing description.

Additional Embodiment of Play Mode ‘Follow Me’

The play mode ‘follow me’ is already described with reference to FIG. 10 and FIG. 11. In the following description, an additional embodiment of the play mode ‘follow me’ is explained in detail.

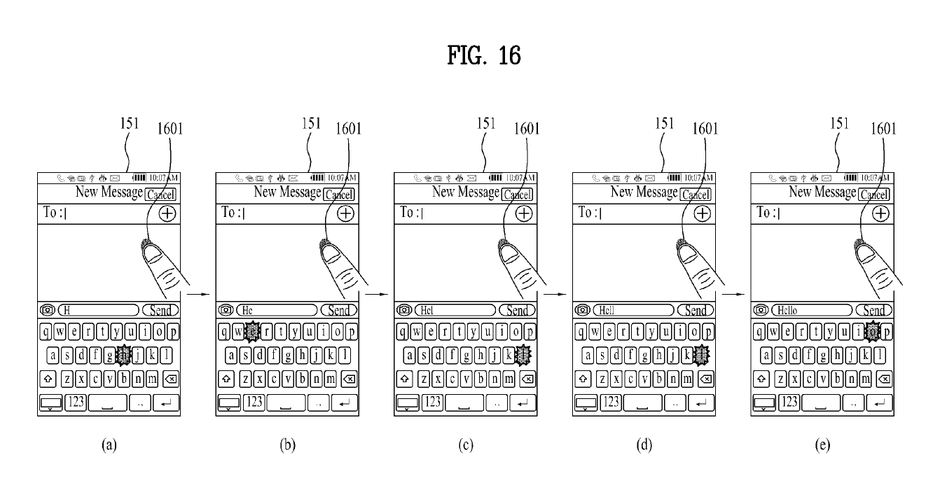

FIG. 16 is a diagram illustrating one example of skipping a touch guide in play mode according to one embodiment of the present invention. As mentioned in the foregoing descriptions with reference to FIG. 10 and FIG. 11, a play mode ‘follow me’ guides a touch from a user and stands by until an input of the touch from the user. However, if there are many and iterative touches, a user may intend to omit the touches. Since a front part of the touches are already known, a user may intend to be guided for the rear part of the touches.

Therefore, according to one embodiment of the present invention, if the controller 180 receives a command for skipping a touch guide, referring to FIGS. 16 (a) to 16 (e), the controller 180 can sequentially display touch guide indicators without standing by for a user's touch input. In this instance, the command for skipping the touch guide may include an input 1601 of pressing a prescribed region of a screen. Until the press input 1601 is cancelled, the controller 180 can sequentially display touch guide indicators (e.g., displayed in order in a prescribed time interval). Referring to FIGS. 16 (a) to 16 (e), the press input 1601 keeps being maintained. Hence, the controller 180 sequentially outputs touch guide indicators for ‘Hello’.

If the command for skipping the touch guide is cancelled (i.e., the press input 1601 is cancelled), the controller 180 can return to the play mode ‘follow me’. In particular, the controller 180 can stand by for a user's touch input to the touch guide indicator.

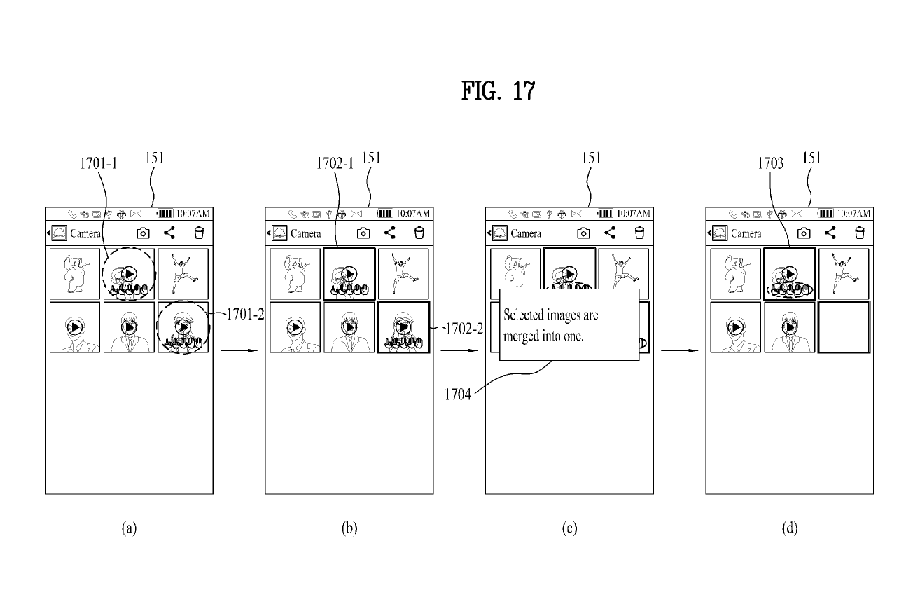

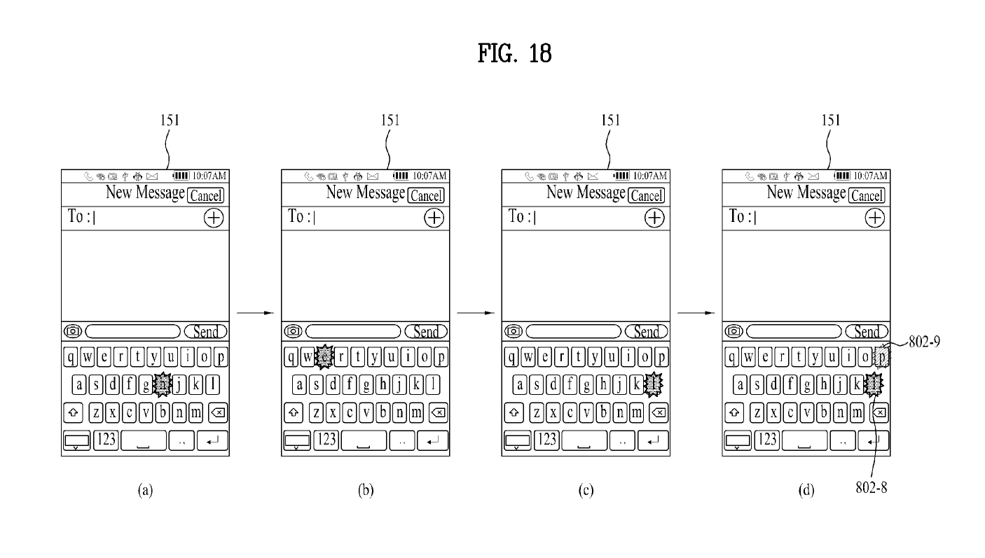

Meanwhile, according to one embodiment of the present invention, it can merge at least two guide contents with each other. A method of merging at least two guide contents together and a method of playing the merged guide contents are described in detail with reference to FIG. 17 and FIG. 18 as follows.

FIG. 17 is a diagram illustrating one example of a method of merging a plurality of guide contents into one according to one embodiment of the present invention. Referring to FIG. 17 (a), a list of photos/videos is currently output in a gallery application. A first guide content 1701-1 and a second guide content 1701-2 are displayed like FIG. 15.

According to one embodiment of the present invention, a controlling method for merging at least two guide contents together is provided. In this instance, target guide contents to be merged together should have the same target application and the same application arrangement screen. In addition, in the target guide contents to be merged together, there should be similarity in touch gesture. As one example of the similarity, if at least 3 touch gestures are identical to each other, the controller 180 can possibly merge the target guide contents into a single image.

FIG. 17 (b) is a diagram of an editing screen of a guide content. In the editing screen, the controller 180 can output an indicator 1702-1/1702-2 indicating that it is a mergeable target guide content.

Referring to FIG. 17 (c), if the controller 180 receives a command for merging a first guide content 1701-1 and a second guide content 1701-2 together, the controller 180 outputs an announcement text 1702 indicating the two contents are merged as one and can then output a merged guide content 1703. In this instance, the merged guide content 1703 may include information on the first guide content 1701-1 and the second guide content 1701-2.

Meanwhile, according to one embodiment of the present invention, when the first guide content 1701-1 and the second guide content 1701-2 are merged into the single merged guide content 1703, the controller 180 can save information on a touch gesture only by deleting ‘image’ information all. The reason for this is that simultaneous playbacks of two images are impossible and that contention may occur between two images when playback of the merged guide content 1703.

According to one embodiment of the present invention, when the controller 180 outputs the merged guide content 1703, the controller 180 can delete a record of one of the touch gesture of the first guide content 1701-1 and the touch gesture of the second guide content 1701-2.

Moreover, according to one embodiment of the present invention, in merging two guide contents with each other, a touch output reference time can be determined with reference to a common touch gesture owned by the two guide contents. For instance, a touch gesture action of pressing an H-key of a keypad is in common between the two guide contents. However, assume that a touch gesture action of pressing the H-key in the first guide content 1701-1 is performed at 3 seconds, and a touch gesture action of pressing the H-key in the second guide content 1701-2 is performed at 10 seconds.

If so, the first guide content 1701-1 and the second guide content 1701-2 can be merged into one with reference to one (e.g., the first guide content 1701-1) of the two guide contents. Hence, a touch gesture action of pressing an H-key in the merged guide content 1703 can be performed in 3 seconds and the rest of touch gestures can be rearranged with reference to a time of pressing the H-key.

In the following description, a method of playing a merged guide content is explained in detail with reference to FIG. 18. In particular, FIG. 18 is a diagram illustrating a method of playing a merged guide content according to one embodiment of the present invention. In order to describe the example shown in FIG. 18, assume that a touch gesture of a first guide content 1701-1 is a touch input of typing ‘Hello’. In addition, assume that a touch gesture of a second guide content 1701-2 is a touch input of typing ‘Help’.

Since a merged guide content 1703 proceeds with the same touch inputs for inputting H-key, E-key and L-key, there are no differences between the two guide contents 1701-1 and 1701-2 in FIGS. 18 (a) to 18 (c). However, in an action of inputting a fourth key, L-key is used for the first guide content 1701-1, whereas P-key is used for the second guide content 1701-2.

Thus, according to one embodiment of the present invention, the controller 180 can control two touch guide indicators to be displayed by being identifiable from each other. For instance, an eighth touch guide indicator 802-8 for the first guide content 1701-1 and a ninth touch guide indicator 802-9 for the second guide content 1701-2 can be displayed in different colors, respectively.

If one of the eighth touch guide indicator 802-8 and the ninth touch guide indicator 802-9 is selected, the controller 180 can continue to output the touch guide indicator for the selected guide only from a timing point of the selection. For instance, if the eighth touch guide indicator 802-8 is selected, the controller 180 can output the touch guide for the first guide content 1701-1 from the timing point of the corresponding selection.

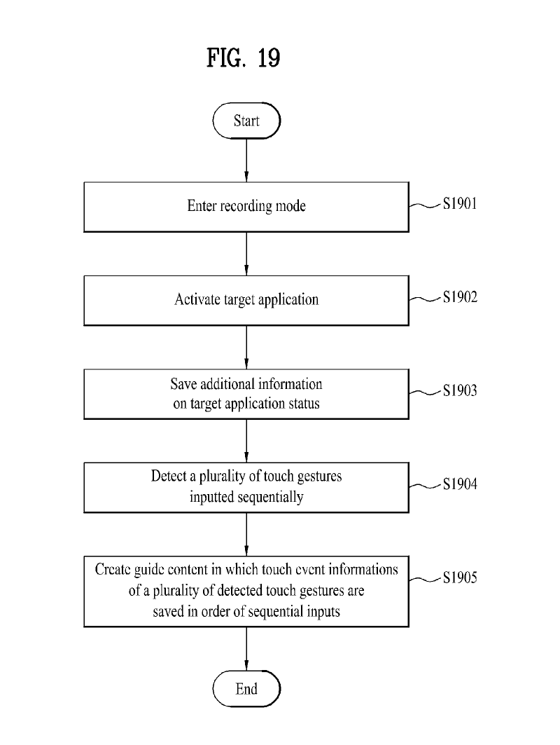

Next, FIG. 19 is a flowchart of a recording operation according to one embodiment of the present invention. Referring to FIG. 9, in a step S1901, the controller 180 can enter a recording mode in response to a user's recording mode entering command. In a step S1902, if the controller 180 receives a command for selecting an activation icon of a target application from the user, the controller 180 can activate the target application.

In a step S1903, the controller 180 can save additional information on a status of the target application. As mentioned in the foregoing description with reference to FIG. 7, the additional information on the target application corresponds to a setting information that can change an output screen of the target application.

In a step S1904, the controller 180 detects a plurality of touch gestures input sequentially. In a step S1905, the controller 180 can create a guide content in which touch event information of a plurality of the detected touch gestures are saved in order of sequential inputs.

Accordingly, embodiments of the present invention provide several advantages.

According to at least one of embodiments of the present invention, it is advantageous in creating/playing a guide content capable of indicating a terminal controlling method easily and intuitively.

The above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a touchscreen;
a memory; and
a controller configured to:
display an active screen of an executing application on the touchscreen,
receive a plurality of touch gestures sequentially inputted to the active screen of the executing application, and
create a guide content by saving touch event information in the memory corresponding to the plurality of the received touch gestures in order of the receiving.

2. The mobile terminal of claim 1, wherein the touch event information comprises touch coordinate information for each of the plurality of the touch gestures.

3. The mobile terminal of claim 2, wherein the touch event information further comprises gesture type information of each of the plurality of the touch gestures, and
wherein the gesture type information comprises at least one of a normal touch type, a long touch type, a touch & drag type, a press type, a multi-touch type, a flicking type, a pinch-in type and a pinch-out type.

4. The mobile terminal of claim 1, wherein the active screen comprises a plurality of touch items, and
wherein the controller is further configured to select a corresponding touch item based on an user input, and save item identification information for the selected touch item.

5. The mobile terminal of claim 4, wherein the controller is further configured to perform a prescribed function corresponding to the touch item and save function identification information of the performed prescribed function.

6. The mobile terminal of claim 1, further comprising:
a microphone,
wherein the controller is further configured to:
receive a voice memo input, via the microphone, while receiving the plurality of touch gestures, and
save the received voice memo input together with the touch event information, wherein the saved voice memo input is timely synchronized with the received plurality of touch gestures.

7. The mobile terminal of claim 1, wherein the controller is further configured to save a touch drag path included in the plurality of touch gestures as a handwriting memo.

8. The mobile terminal of claim 1, wherein the controller is further configured to output a play screen of the created guide content to the touchscreen, and
wherein the play screen comprises the active screen and a plurality of touch guide indicators sequentially displaying the plurality of the input touch gestures on the active screen, respectively.

9. The mobile terminal of claim 8, wherein in outputting the play screen, the controller is further configured to display a first indicator among the plurality of touch guide indicators, and if an input of touching the first indicator is received, display a second indicator in response to the received input.

10. The mobile terminal of claim 9, wherein the second indicator comprises an indicator in order right next to the first indicator among the plurality of touch guide indicators.

11. A method of controlling a mobile terminal, the method comprising:
displaying, via a touchscreen of the mobile terminal, an active screen of an executing application;
receiving, via the touchscreen, a plurality of touch gestures sequentially inputted to the active screen of the executing application; and
creating, via the controller, a guide content by saving touch event information in the memory corresponding to the plurality of the received touch gestures in order of the receiving.

12. The method of claim 11, wherein the touch event information comprises touch coordinate information for each of the plurality of the touch gestures.

13. The method of claim 12, wherein the touch event information further comprises gesture type information of each of the plurality of the touch gestures, and
wherein the gesture type information comprises at least one of a normal touch type, a long touch type, a touch & drag type, a press type, a multi-touch type, a flicking type, a pinch-in type and a pinch-out type.

14. The method of claim 11, wherein the active screen comprises a plurality of touch selectable items, and
wherein the method further comprises selecting a corresponding touch selectable item based on an user input, and saving item identification information for the selected touch item.

15. The method of claim 14, further comprising:
performing a prescribed function corresponding to the selected touch item; and
saving function identification information of the performed prescribed function.

16. The method of claim 11, further comprising:
receiving a voice memo input, via a microphone, while receiving the plurality of touch gestures, and
saving the received voice memo input together with the touch event information, wherein the saved voice memo input is timely synchronized with the received plurality of touch gestures.

17. The method of claim 11, further comprising:
saving a touch drag path included in the plurality of touch gestures as a handwriting memo.

18. The method of claim 11, further comprising:
outputting a play screen of the created guide content to the touchscreen,
wherein the play screen comprises the active screen and a plurality of touch guide indicators sequentially displaying the plurality of the input touch gestures on the active screen, respectively.

19. The method of claim 18, further comprising:
displaying a first indicator among the plurality of touch guide indicators; and
if an input of touching the first indicator is received, displaying a second indicator in response to the received input.

20. The method of claim 19, wherein the second indicator comprises an indicator in order right next to the first indicator among the plurality of touch guide indicators.
